(19) United States
(12) Patent Application Publication
(10) Pub. No.: US 2026/0282013 A1
(43) Pub. Date: Sep. 17, 2026

(54) AN OPTIMIZATION TO IMPROVE PERFORMANCE AND POWER-SAVING FOR DL SPS WITH UE TX INTERRUPTION

(71) Applicant: QUALCOMM Incorporated, San Diego, CA (US)

(72) Inventors: Peng LIU, Xi'an (CN); Zhiliang ZHENG, Beijing (CN); Ling XIE, Beijing (CN); Peng WU, Shanghai (CN); Jie REN, Xi'an (CN); Weixuan JIN, Shijiazhuang (CN); Tom CHIN, San Diego, CA (US)

(21) Appl. No.: 19/473,462

(22) PCT Filed: May 26, 2023
(86) PCT No.: PCT/CN2023/096446

§ 371 Date: Oct. 7, 2025

(51) Int. Cl. H04W 72/1273; H04W 72/21

(52) U.S. Cl. CPC H04W 72/1273; H04W 72/21

(57) ABSTRACT

A method for wireless communication at a user equipment (UE) and related apparatus are provided. In the method, the UE obtains a configuration for downlink (DL) semi-persistent scheduling (SPS), and activates the DL SPS for the reception of DL data at a periodicity. The UE further monitors for one or more transmissions associated with the DL SPS based on the periodicity, and deactivates the DL SPS based on the one or more transmissions. The method improves performance in DL SPS and reduces power consumption by eliminating unnecessary UL transmissions and PDSCH decoding when DL SPS status is misaligned between UE and the network.

### TECHNICAL FIELD

The present disclosure relates generally to communication systems, and, more particularly, to performance improvement and power-saving for downlink (DL) semi-persistent scheduling (SPS) with user equipment (UE) transmission (Tx) interruption.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a UE. The apparatus may include memory and at least one processor coupled to the memory. Based at least in part on information stored in the memory, the at least one processor may be configured to obtain a configuration for DL SPS; activate the DL SPS for the reception of DL data at a periodicity, where the periodicity is based on the configuration; monitor for one or more transmissions associated with the DL SPS based on the periodicity; and deactivate the DL SPS based on the one or more transmissions.

In an aspect of the disclosure, a method, a computer-readable medium, and an apparatus are provided for wireless communication at a network entity. The apparatus may include memory and at least one processor coupled to the memory. Based at least in part on information stored in the memory, the at least one processor may be configured to transmit, for a UE, a configuration for DL SPS; receive from, or transmit to, the UE one or more transmissions associated with the DL SPS for the UE to determine the status of the DL SPS based on the one or more transmissions; and communicate, based on the status of the DL SPS, with the UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of UE Tx interruption causing DL SPS status misalignment between the UE and the network.

FIG. 5 is a diagram illustrating an example of multiple subscriber identity module (MSIM) Tx interruption causing DL SPS status misalignment.

FIG. 6 is a diagram illustrating an example of single subscriber identity module (SSIM) Tx interruption causing DL SPS status misalignment.

FIG. 7 is a call flow diagram illustrating a method of wireless communication in accordance with various aspects of the present disclosure.

FIG. 8 is a flowchart illustrating methods of wireless communication at a UE in accordance with various aspects of the present disclosure.

FIG. 9 is a flowchart illustrating methods of wireless communication at a UE in accordance with various aspects of the present disclosure.

FIG. 10 is a flowchart illustrating methods of wireless communication at a network entity in accordance with various aspects of the present disclosure.

FIG. 11 is a flowchart illustrating methods of wireless communication at a network entity in accordance with various aspects of the present disclosure.

FIG. 12 is a diagram illustrating an example of a hardware implementation for an example apparatus and/or network entity.

FIG. 13 is a diagram illustrating an example of a hardware implementation for an example network entity.

### DETAILED DESCRIPTION

Various aspects relate generally to communication systems. Some aspects more specifically relate to performance improvement and power-saving for DL SPS with UE transmission interruption. In some examples, a UE obtains a configuration for DL SPS, and activates the DL SPS for the reception of DL data at a periodicity, where the periodicity is based on the configuration. The UE further monitors for one or more transmissions associated with the DL SPS based on the periodicity; and deactivates the DL SPS based on the one or more transmissions. The UE may deactivate the DL SPS when there is a misalignment in the DL SPS statuses between the UE and the network, and the deactivation may be implemented by triggering a random-access channel (RACH) on the active bandwidth part (BWP) to deactivate all DL SPS on the UE or by deactivating a DL SPS set associated with the one or more transmissions.

Particular aspects of the subject matter described in this disclosure can be implemented to realize one or more of the following potential advantages. In some examples, the described techniques can improve the performance of wireless communication by deactivating the DL SPS when a misalignment in the DL SPS statuses between the UE and the network is detected. Additionally, these techniques can help reduce power consumption by eliminating unnecessary physical uplink control channel (PUCCH)/physical uplink shared channel (PUSCH) uplink transmissions and physical downlink shared channel (PDSCH) decoding that may occur when the DL SPS statuses are misaligned.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well-known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

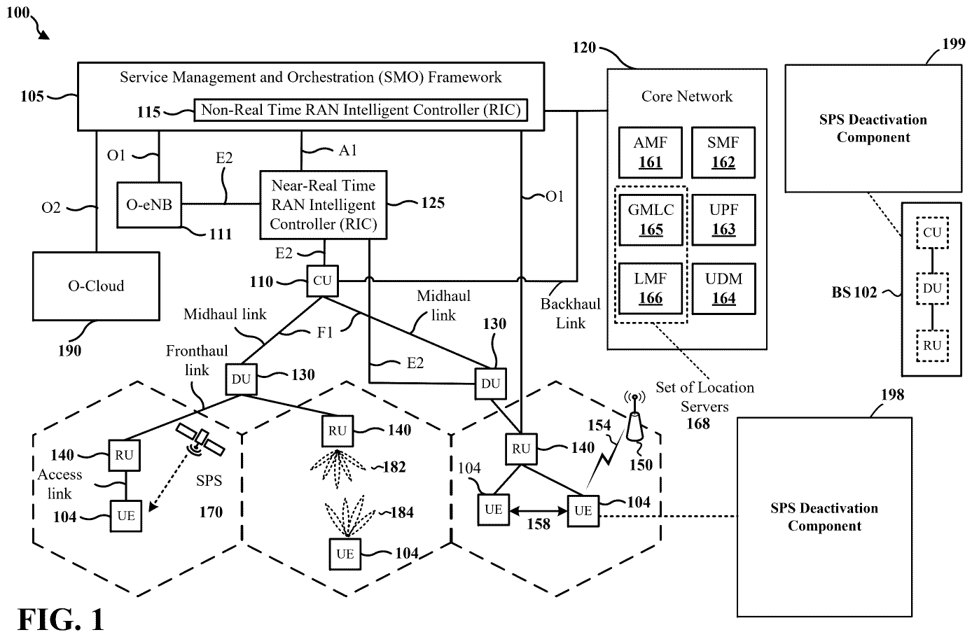

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an SPS deactivation component 198. The SPS deactivation component 198 may be configured to obtain a configuration for DL SPS; activate the DL SPS for the reception of DL data at a periodicity, where the periodicity is based on the configuration; monitor for one or more transmissions associated with the DL SPS based on the periodicity; and deactivate the DL SPS based on the one or more transmissions. In certain aspects, base station 102 may include an SPS deactivation component 199. The SPS deactivation component 199 may be configured to transmit, for a UE, a configuration for DL SPS; receive from, or transmit to, the UE one or more transmissions associated with the DL SPS for the UE to determine the status of the DL SPS based on the one or more transmissions; and communicate, based on the status of the DL SPS, with the UE. Although the following description may be focused on 5G NR, the concepts described herein may be applicable to other similar areas, such as LTE, LTE-A, CDMA, GSM, and other wireless technologies.

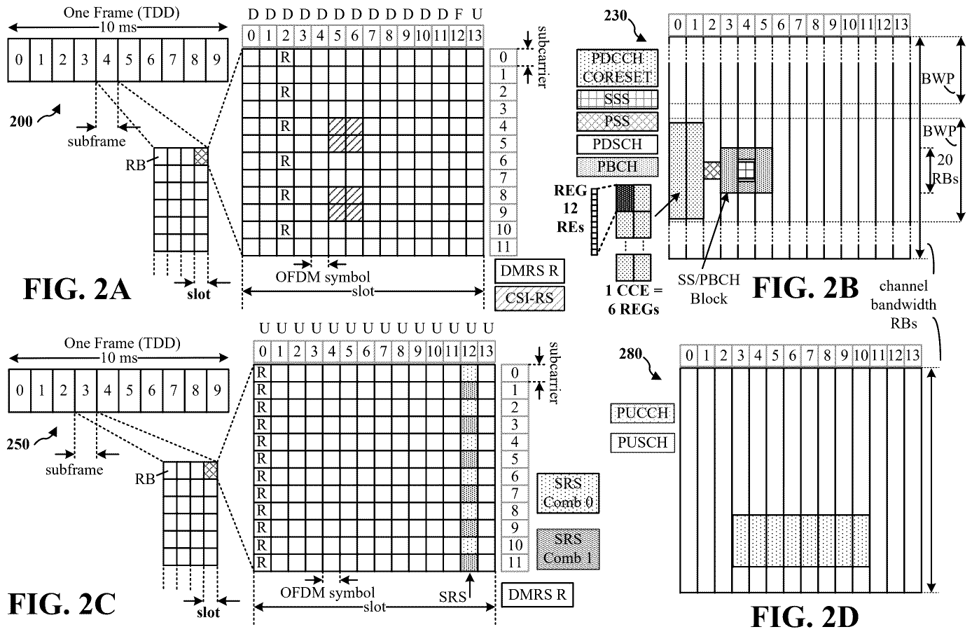

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control 1 information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The PDSCH carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the PUCCH and DM-RS for the PUSCH. The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

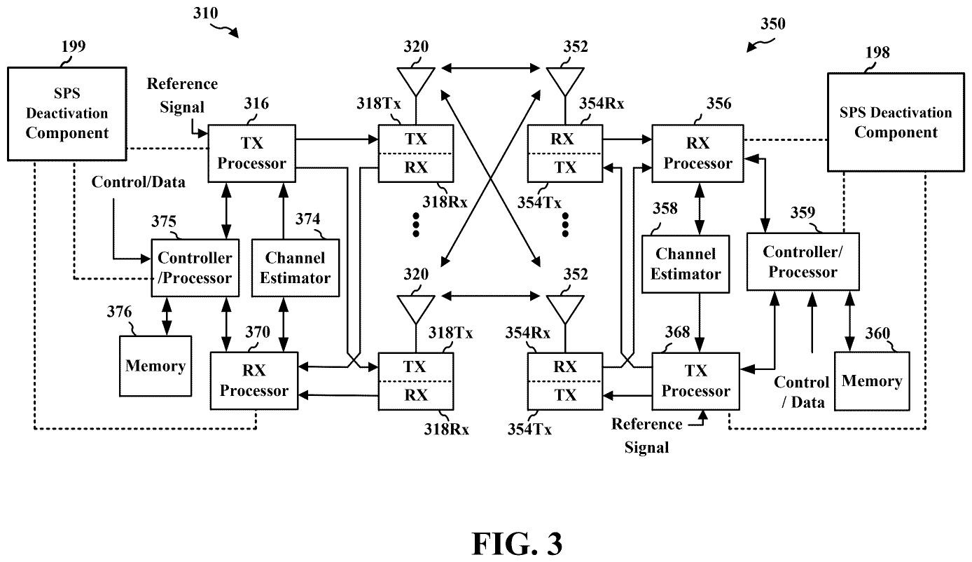

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the SPS deactivation component 198 of FIG. 1.

At least one of the TX processor 316, the RX processor 370, and the controller/processor 375 may be configured to perform aspects in connection with the SPS deactivation component 199 of FIG. 1.

Example aspects presented herein relate to a method for detecting and mitigating misalignments in DL SPS activation and deactivation between a UE and a network in a wireless communication network. For DL SPS activation or deactivation misaligned between the UE and the network (e.g., gNB) due to TX interruption (for MSIM) or TX suspend (for SSIM), example aspects propose ways to detect and to mitigate such misalignment. Detection is via counters of decoding errors and radio condition criteria. Mitigation is via DL SPS reset (i.e., DL SPS disabled by default) using RACH initiation or local deactivation of DL SPS. The proposed solutions reduce power consumption due to unnecessary DCI decoding caused by misaligned activation of DL SPS between the UE and the network (e.g., gNB). As used herein, the term “network” may refer to a network entity (e.g., a next-generation NodeB, or a gNB), a base station, or one or more components of a base station (e.g., such as a CU 110, a DU 130, and/or an RU 140). The term “MSIM transmission” refers to the transmission through devices with multiple SIM card support, “SSIM transmission” refers to the transmission through devices with single SIM card support, “transmission (TX) interruptions for MSIM” refers to a disruption in the transmission when using a device with multiple SIM card support (e.g., due to switching between the SIM cards), and “transmission (TX) suspension for SSIM” refers to a temporary halt in the transmission when using a device with a single SIM card support (e.g., due to the priority of the transmission).

DL SPS is a mechanism in which a network entity (e.g., a next-generation NodeB, or a gNB) may schedule a PDSCH without using DCI for every transmission. This method may significantly save PDCCH resources for the downlink periodic traffic, such as voice over New Radio (VoNR) and other similar services. The network entity may specify all the DL SPS necessary scheduling parameters in RRC per SPS sets and use a configured scheduling radio network temporary identifier (CS-RNTI) scrambled DCI to activate or deactivate the corresponding SPS set. Multiple DL SPS sets may be configured, activated or deactivated individually.

In a dual-SIM dual-active (DSDA) scenario, when two SIMs are concurrently in a connected state, both may experience radio frequency (RF) limitations on transmission (Tx) and reception (Rx). The typical impact of multi-SIM (MSIM) Tx limitations is the micro priority pattern (MPP) internal or external drop due to other high-priority activities. These MSIM Tx limitations may cause a whole or partial Tx drop, leading to a misalignment between the UE and the network DL-SPS statuses.

In the context of DL SPS and MSIM or SSIM, the network vendor may support DL SPS, enabling its use in a live network. However, when the UL feedback of DL SPS activation overlaps with MSIM or SSIM transmission limitations, the UE's acknowledgment (ACK) feedback for DL SPS activation may be dropped. This may result in a misalignment between the UE and the network's DL SPS statuses. The UE may continue to decode the DL SPS PDSCH per SPS periodicity, while the network may recognize DL SPS as deactivated due to the absence of ACK feedback, thus stopping DL SPS PDSCH transmission. This misalignment may cause a substantial increase in DL block error rate (BLER) and potentially a significant increase in UL BLER.

Example aspects presented herein provide a method to address this challenge by deactivating DL SPS on the UE side when MSIM or SSIM transmission interruptions cause a misalignment between the UE and the network's DL SPS statuses. The method aims to improve the performance and power-saving of DL SPS in both MSIM and SSIM scenarios by quickly re-aligning the UE and the network's DL SPS statuses.

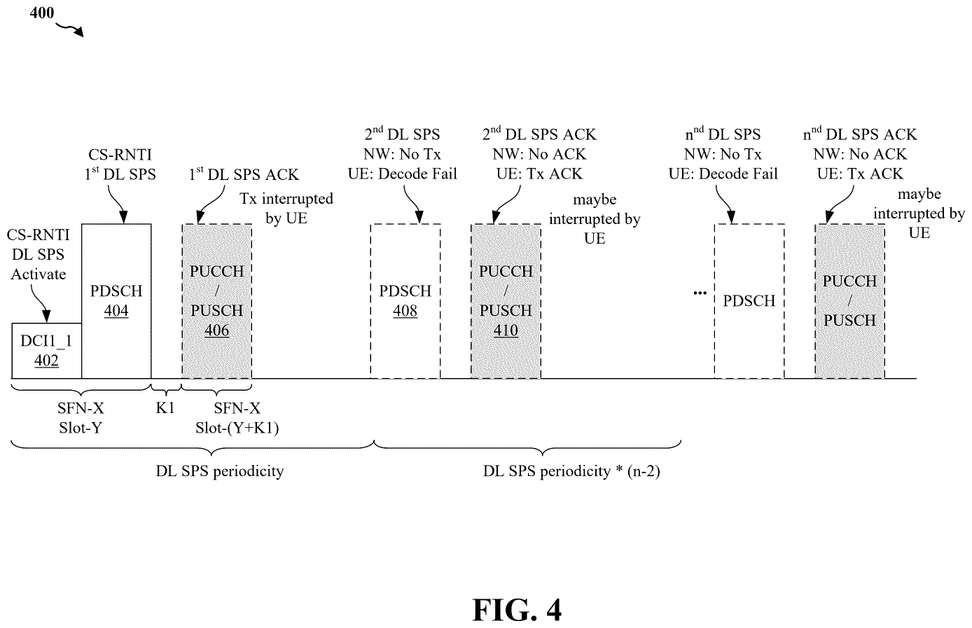

FIG. 4 is a diagram 400 illustrating an example of UE Tx interruption causing DL SPS status misalignment between the UE and the network. In FIG. 4, the UE may first receive a configuration (not shown in FIG. 4) from, for example, a base station, for DL SPS. The configuration may be received through OTA signaling. Then, DL SPS is activated at system frame number (SFN) X, slot Y, by a CS-RNTI scrambled DCI1_1 402. Consequently, the UE may successfully decode the first DL SPS PDSCH 404 at the same SFN/slot. Due to the UE Tx interruption, the PUCCH or PUSCH 406 carrying the ACK feedback for DL SPS activation at SFN X, slot (Y+K1) may be interrupted by the UE. From this point onward, the UE may consider the DL SPS as activated, while the network may recognize the DL SPS as deactivated, resulting in a misalignment of DL SPS statuses between the UE and the network.

As per the DL SPS periodicity, on the second DL SPS PDSCH 408 occasion, the network may not transmit PDSCH 408, but the UE may attempt to decode it. This may lead to a 100% decoding failure on the PDSCH 408. During the second DL SPS ACK feedback occasion, the UE may carry the DL SPS ACK in PUCCH/PUSCH 410, causing additional power consumption in PUCCH or a 100% PUSCH failure due to a mismatch in the multiplexed ACK bits between the UE and the network. The same issue may occur for all the remaining n^{th} DL SPS occasions.

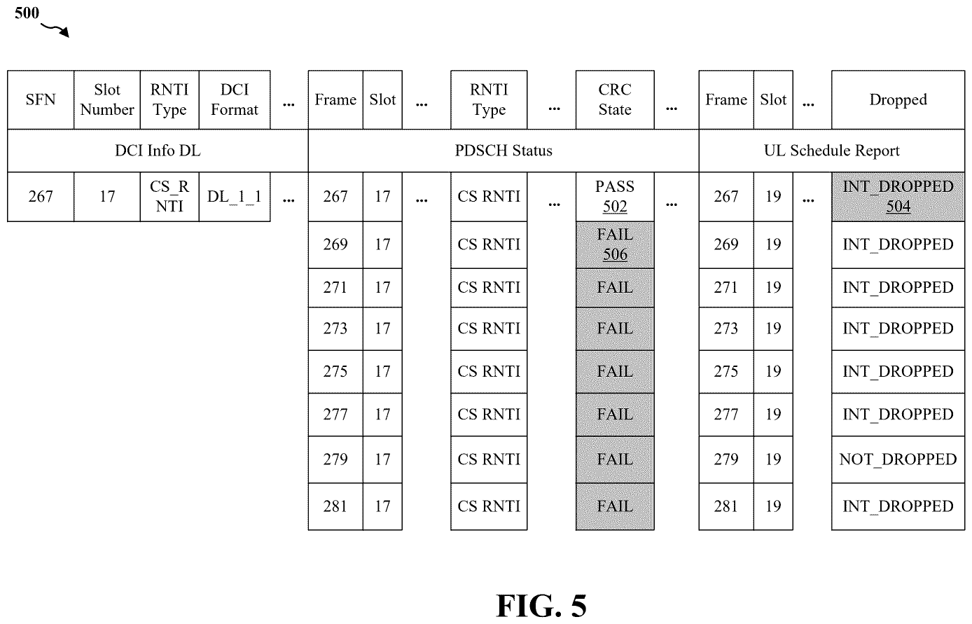

FIG. 5 is a diagram 500 illustrating an example of MSIM Tx interruption causing DL SPS status misalignment. In FIG. 5, the DL SPS may be activated on SFN 267, slot 17, by a CS-RNTI scrambled DCI1_1. As a result, the UE may successfully decode the first DL SPS PDSCH on the same SFN 267, slot 17 (e.g., indicated by the cyclic redundancy check (CRC) PASS 502).

Due to the MSIM Tx limitations, the PUCCH carrying the ACK feedback for DL SPS activation on SFN 267, slot 19, may be interrupted by the UE (e.g., indicated by INT_DROPPED 504). From SFN 267, slot 19 onward, the UE may recognize the DL SPS as activated, while the network may recognize it as deactivated, leading to a misalignment of the DL SPS statuses between the UE and the network.

According to the configured 20 ms DL SPS periodicity, on the second DL SPS PDSCH occasion at SFN 269, slot 17, the UE's PDSCH decoding may fail (e.g., indicated by the CRC FAIL 506) since the network does not transmit it. On the second DL SPS ACK feedback occasion at SFN 269, slot 19, the UE may carry the DL SPS ACK in PUCCH, but the network may not decode it, resulting in additional power consumption for the UE. If the UE multiplexes this DL SPS ACK in the PUSCH, it will cause a 100% failure of the PUSCH. This issue may persist for all the remaining DL SPS occasions, such as SFN 271, slot 17; SFN 273, slot 17; SFN 275, slot 17; SFN 277, slot 17; SFN 279, slot 17; and SFN 281, slot 17, among others. As used herein, “CRC” (or cyclic redundancy check) refers to an error-detecting technique used to ensure the integrity of data being transmitted. “CRC PASS” means the CRC check determines that the data has not been altered or corrupted during the transmission, and “CRC FAIL” means the CRC check detects an inconsistency between the received data and the original data (i.e., the data has been altered or corrupted during the transmission).

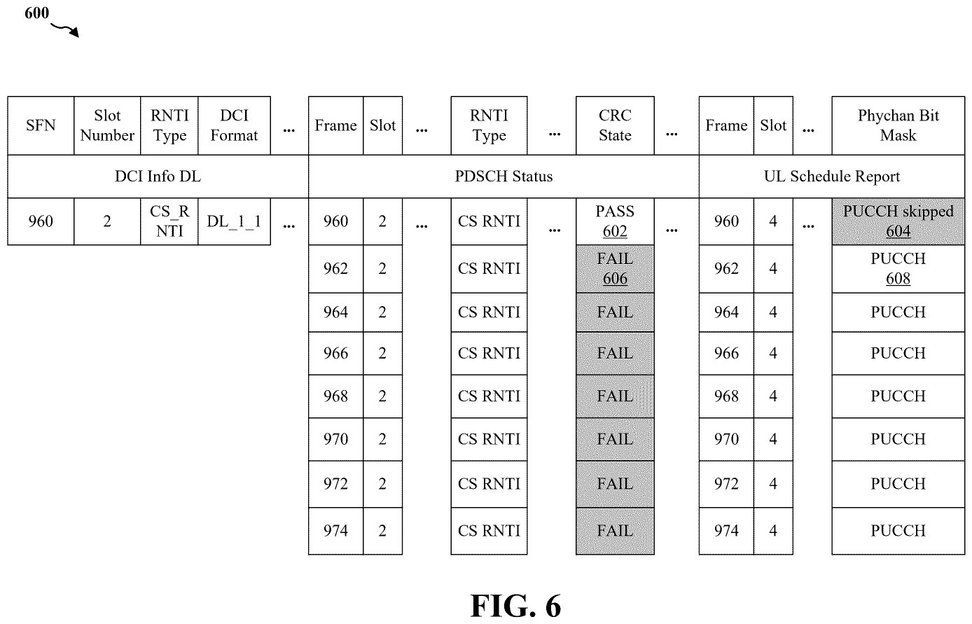

FIG. 6 is a diagram 600 illustrating an example of SSIM Tx interruption causing DL SPS status misalignment. In FIG. 6, the DL SPS may be activated on SFN 960, slot 2, by a CS-RNTI scrambled DCI1_1. As a result, the UE may successfully decode the first DL SPS PDSCH on the SFN 960, slot 2 (e.g., indicated by the CRC state PASS 602).

Due to SSIM UL Tx skip, the PUCCH carrying the ACK feedback for DL SPS activation on SFN 960, slot 4, may be interrupted by the UE (e.g., indicated by the PUCCH skipped 604). From SFN 960, slot 4, onward, the UE may recognize the DL SPS as activated, while the network may recognize it as deactivated, leading to a misalignment of DL SPS statuses between the UE and the network.

According to the configured DL SPS periodicity of, for example, 20 ms, on the second DL SPS PDSCH occasion at SFN 962, slot 2, the UE's PDSCH decoding may fail (e.g., indicated by the CRC state FAIL 606) since the network does not transmit it. On the second DL SPS ACK feedback occasion at SFN 962, slot 4, the UE may carry the DL SPS ACK in PUCCH 608, but the network may not decode it, resulting in additional power consumption for the UE. If the UE multiplexes this DL SPS ACK in the PUSCH, it will cause a 100% failure of the PUSCH. This issue may persist for all the remaining DL SPS occasions, such as SFN 964, slot 2; SFN 966, slot 2; SFN 968, slot 2; SFN 970, slot 2; SFN 972, slot 2; and SFN 974, slot 2, among others.

Example aspects presented herein provide a method to deactivate DL SPS on the UE side by triggering a RACH or local deactivation, allowing for a quick re-alignment of the DL SPS statuses between the UE and the network when UE Tx interruptions occur, such as due to MSIM Tx limitations or SSIM Tx suspend/skip scenarios.

In some aspects, a Media Access Control (MAC) entity (e.g., a MAC entity in a UE) may first determine if DL SPS has been configured by the network. If a DL SPS has been configured, the MAC entity may check if PUCCH/PUSCH Tx is interrupted by the UE (e.g., due to MSIM Tx limitation or SSIM Tx suspend/skip) when carrying ACK/NACK feedback for the CS-RNTI PDSCH of a specific DL SPS set activation.

In some examples, the MAC entity may monitor X times CS-RNTI PDSCH occasions and Y times PUSCH occasions for this specific DL SPS set. The Y times PUSCH occasions may carry the SPS or type 2 Affirmative/Negative feedback (A/N feedback) for this specific DL SPS set, and the transmissions of the Y times PUSCH occasions are not interrupted by the UE. X and Y may be counters and may be configurable parameters.

In some aspects, if all X times CS-RNTI PDSCH occasions have CRC failed and no DL SPS retransmission occurs, and a normal operating condition is met, the UE may deactivate the DL SPS. The deactivation of the DL SPS may be implemented by, for example, triggering RACH on the active BWP to deactivate all DL SPS or locally deactivating the specific DL SPS set based on different traffic types. The normal operating condition may be evaluated through various criteria. In some examples, the normal operating condition may be considered met if the RSRP is greater than an RSRP threshold R, the SSB signal-to-noise ratio (SNR) is greater than an SNR threshold S, or at least one PDSCH CRC has passed in the duration of X CS-RNTI PDSCH's running. The RSRP threshold R and the SNR threshold S may be configurable parameters.

In some aspects, if all Y times PUSCH occasions have received negative feedback (e.g., NACK) by the network, and if the normal operating condition is met, the UE may deactivate the DL SPS. The deactivation of the DL SPS may be implemented by, for example, triggering RACH on the active BWP to deactivate all DL SPS or locally deactivating the specific DL SPS set based on different traffic types. The normal operating condition may be evaluated through various criteria. In some examples, the normal operating condition may be considered met if the RSRP is greater than RSRP threshold R, the SSB SNR is greater than SNR threshold S, or at least one PUSCH has received an acknowledgement (e.g., ACK) from the network in the duration of Y PUSCH's running.

In some aspects, if the UE receives a CS-RNTI DCI to deactivate or reactivate a specific DL SPS set, the UE may follow the existing procedure to deactivate or reactive the specific DL SPS. In all other cases, the UE may follow the existing procedure regarding the activation or deactivation of the DL SPS as well.

Example aspects presented herein provide a method to effectively address DL SPS status misalignment between the UE and the network in MSIM and SSIM scenarios. By triggering a RACH to deactivate all DL SPS or locally deactivating a specific DL SPS set on the UE side, this method allows for the rapid re-alignment of DL SPS statuses between the UE and the network when misalignment occurs due to, for example, MSIM/SSIM Tx interruptions. This quick re-alignment of DL SPS statuses improves the performance in commercial scenarios involving DL SPS and MSIM/SSIM configurations. Moreover, the proposed method helps conserve power by reducing the energy consumption associated with unnecessary DL SPS-related PUCCH/PUSCH UL transmissions and PDSCH decoding when misalignment between the UE and network is present.

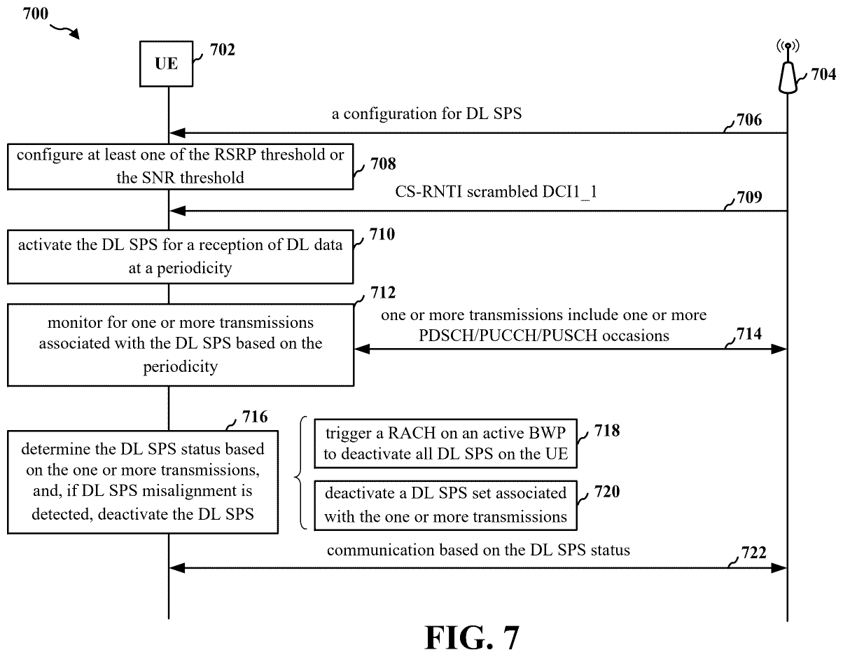

FIG. 7 is a call flow diagram 700 illustrating a method of wireless communication in accordance with various aspects of this present disclosure. Example aspects are described in connection with a UE 702 and a base station 704. Various aspects may be performed by a base station in aggregation and/or by one or more components of a base station 704 (e.g., such as a CU 110, a DU 130, and/or an RU 140), or by UE 702.

As shown in FIG. 7, a UE 702 may, at 706, obtain from base station 704 a configuration for DL SPS. The configuration for DL SPS may be obtained based on OTA signaling. For example, referring to FIG. 4, the UE may receive from a base station a configuration for DL SPS.

At 708, UE 702 may configure at least one of the RSRP threshold and the SNR threshold. For example, referring to FIG. 4, the UE may configure at least one of the RSRP threshold and the SNR threshold.

At 709, UE 702 may receive the CS-RNTI scrambled DCI1_1 from base station 704. For example, referring to FIG. 4, the UE may receive the CS-RNTI scrambled DCI1_1 402 from a base station.

At 710, UE 702 may activate the DL SPS for the reception of DL data at a periodicity based on the CS-RNTI scrambled DCI1_1 (received at 709). The periodicity may be based on the configuration (received at 706). For example, referring to FIG. 4, based on the CS-RNTI scrambled DCI1_1 402, the UE may activate the DL SPS for the reception of DL data at a periodicity (e.g., the reception of DL SPS PDSCH at 404, 408, etc.). The periodicity may be based on the configuration.

At 712, UE 702 may monitor for one or more transmissions associated with the DL SPS based on the periodicity. In some aspects, at 714, the one or more transmissions may include one or more PDSCH occasions based on the periodicity, one or more PUCCH occasions based on the periodicity, or one or more PUSCH occasions based on the periodicity. For example, referring to FIG. 4, the UE may monitor one or more PDSCH occasions (e.g., PDSCH 408), one or more PUCCH occasions, or one or more PUSCH occasions (e.g., PUCCH/PUSCH 410) based on the periodicity. As used herein, the term “PUSCH occasion” refers to the time and frequency resources allocated for the transmission of user data or control information on the PUSCH, and “PDSCH occasion” refers to the time and frequency resources allocated for the transmission of user data or control information on the PDSCH.

At 716, UE 702 may determine the DL SPS status based on the one or more transmissions. For example, UE 702 may determine whether there exists DL SPS misalignment between UE 702 and base station 704. When the DL SPS misalignment is detected, UE 702 may deactivate the DL SPS. In some examples, UE 702 may deactivate the DL SPS if the set of DL SPS misalignment criteria is met. In one example, the DL SPS misalignment criteria may include X times CS-RNTI PDSCH occasions have CRC failed and no DL SPS retransmission occurs, and a first normal operating condition is met. In another example, the DL SPS misalignment criteria may include all Y times PUSCH occasions have received negative feedback (e.g., NACK) by the network, and a second normal operating condition is met. X and Y are configurable parameters.

To deactivate the DL SPS, in some examples, UE 702 may, at 718, trigger a RACH on the active BWP to deactivate all DL SPS on the UE. In some examples, UE 702 may, at 720, deactivate a DL SPS set associated with the one or more transmissions. For example, referring to FIG. 4, based on the monitoring of one or more transmissions (e.g., PDSCH 408, or PUCCH/PUSCH 410), the UE may deactivate the DL SPS. The UE may deactivate the DL SPS by triggering a RACH on the active BWP or by deactivating all DL SPS associated with the one or more transmissions (e.g., PDSCH 408, or PUCCH/PUSCH 410).

In some aspects, at 722, base station 704 may communicate with UE 702 based on the DL SPS status. The DL SPS status may be determined by UE 702 based on the one or more transmissions (at 714).

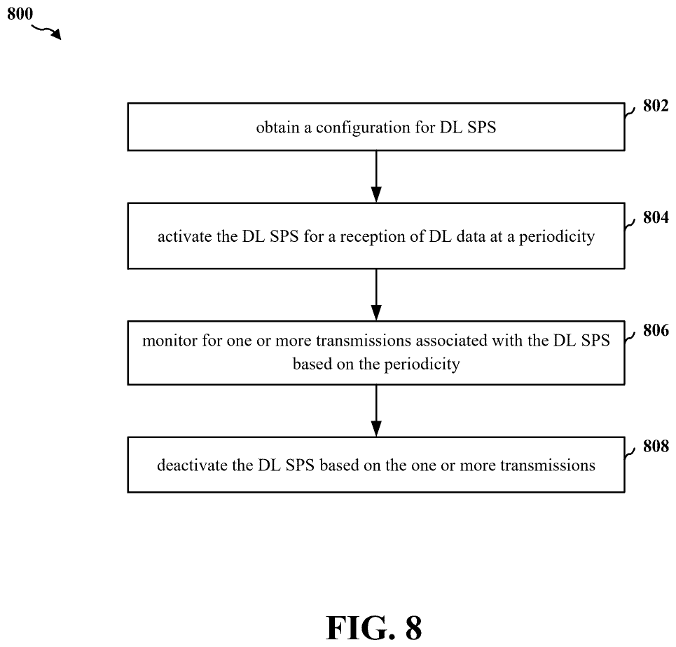

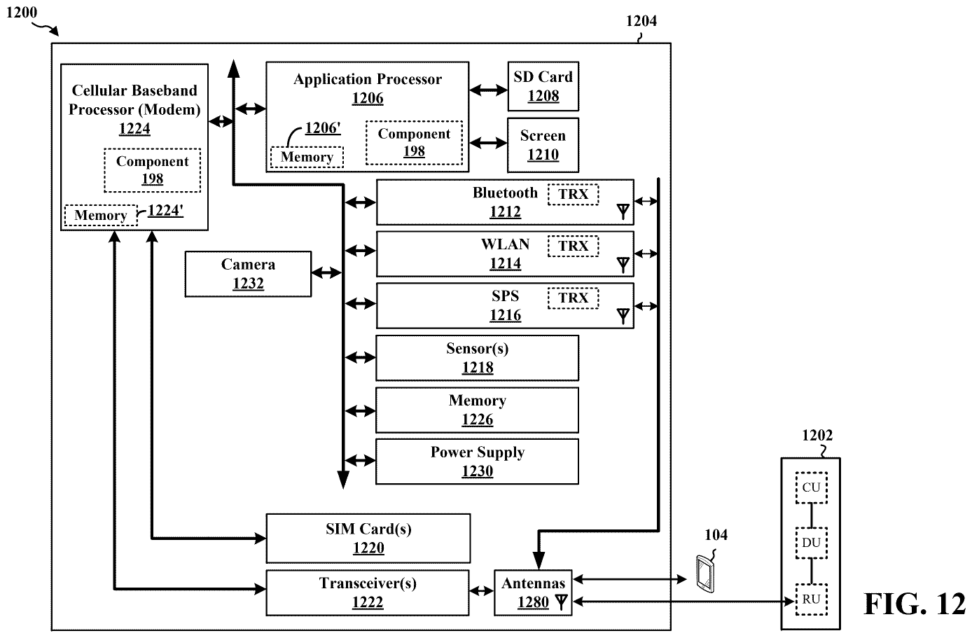

FIG. 8 is a flowchart 800 illustrating methods of wireless communication at a UE in accordance with various aspects of the present disclosure. The method may be performed by a UE. The UE may be the UE 104, 350, 702, or the apparatus 1204 in the hardware implementation of FIG. 12. The methods address the issue of DL SPS status misalignment between the UE and the network in MSIM and SSIM scenarios. The misalignment may lead to significant DL and UL block error rates and increased power consumption. The methods involve deactivating DL SPS on the UE side through triggering RACH or local deactivation, which quickly re-aligns the DL SPS status with the network. The methods improve performance in DL SPS and reduce power consumption by eliminating unnecessary UL transmissions and PDSCH decoding when DL SPS status is misaligned between UE and the network.

As shown in FIG. 8, at 802, the UE may obtain a configuration for DL SPS. The configuration may be obtained based on OTA signaling. The network entity may be a base station, or a component of a base station, in the access network of FIG. 1 or a core network component (e.g., base station 102, 310, 704; or the network entity 1202 in the hardware implementation of FIG. 12). FIGS. 4, 5, 6, and 7 illustrate various aspects of the steps in connection with flowchart 800. For example, referring to FIG. 7, UE 702 may, at 706, obtain a configuration for DL SPS from base station 704. Referring to FIG. 4, the UE may receive from a base station a configuration for DL SPS. In some aspects, 802 may be performed by the SPS deactivation component 198. At 804, the UE may activate the DL SPS for the reception of DL data at a periodicity. The periodicity may be based on the configuration. For example, referring to FIG. 7, UE 702 may activate, at 710, based on the CS-RNTI scrambled DCI1_1 (received at 709), the DL SPS for the reception of DL data at a periodicity. The periodicity may be based on the configuration (received at 706). Referring to FIG. 4, based on the CS-RNTI scrambled DCI1_1 402, the UE may activate the DL SPS for the reception of DL data at a periodicity (e.g., the reception of DL SPS PDSCH at 404, 408, etc.). In some aspects, 804 may be performed by the SPS deactivation component 198.

At 806, the UE may monitor for one or more transmissions associated with the DL SPS based on the periodicity. For example, referring to FIG. 7, UE 702 may, at 712, monitor for one or more transmissions associated with the DL SPS based on the periodicity. In some aspects, 806 may be performed by the SPS deactivation component 198.

At 808, the UE may deactivate the DL SPS based on the one or more transmissions. For example, referring to FIG. 7, UE 702 may deactivate, at 716, the DL SPS based on the one or more transmissions. In some aspects, 808 may be performed by the SPS deactivation component 198.

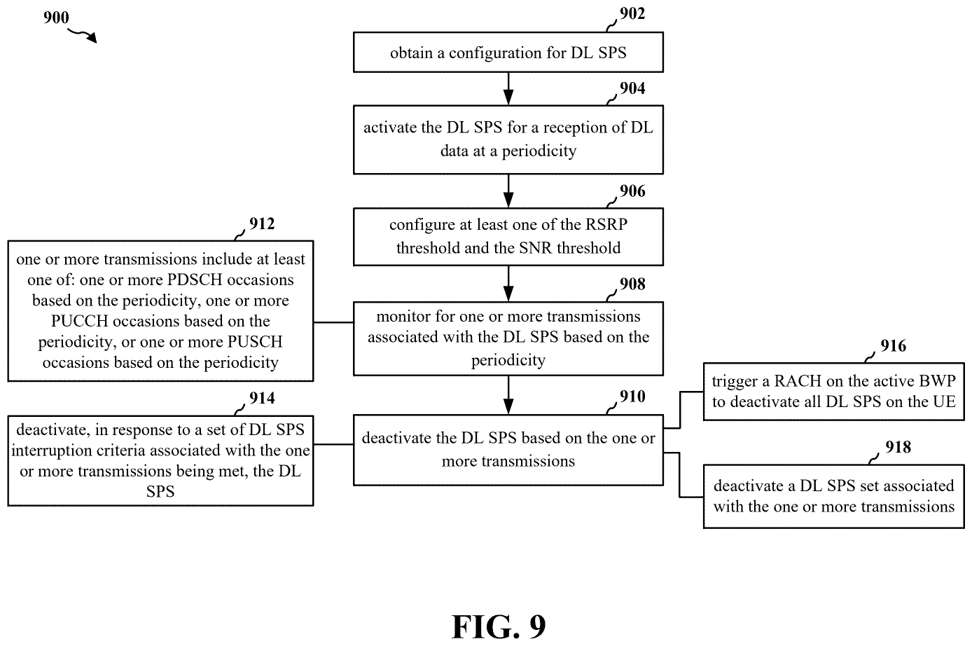

FIG. 9 is a flowchart 900 illustrating methods of wireless communication at a UE in accordance with various aspects of the present disclosure. The method may be performed by a UE. The UE may be the UE 104, 350, 702, or the apparatus 1204 in the hardware implementation of FIG. 12. The methods address the issue of DL SPS status misalignment between the UE and the network in MSIM and SSIM scenarios. The misalignment may lead to significant DL and UL block error rates and increased power consumption. The methods involve deactivating DL SPS on the UE side through triggering RACH or local deactivation, which quickly re-aligns the DL SPS status with the network. The methods improve performance in DL SPS and reduce power consumption by eliminating unnecessary UL transmissions and PDSCH decoding when DL SPS status is misaligned between UE and the network.

As shown in FIG. 9, at 902, the UE may obtain a configuration for DL SPS. The configuration may be obtained based on OTA signaling. The network entity may be a base station, or a component of a base station, in the access network of FIG. 1 or a core network component (e.g., base station 102, 310, 704; or the network entity 1202 in the hardware implementation of FIG. 12). FIGS. 4, 5, 6, and 7 illustrate various aspects of the steps in connection with flowchart 900. For example, referring to FIG. 7, UE 702 may, at 706, obtain a configuration for DL SPS from base station 704. Referring to FIG. 4, the UE may receive from a base station a configuration for DL SPS. The DL SPS configuration may be received based on OTA signaling. In some aspects, 902 may be performed by the SPS deactivation component 198.

At 904, the UE may activate the DL SPS for the reception of DL data at a periodicity. The periodicity may be based on the configuration. For example, referring to FIG. 7, For example, referring to FIG. 7, UE 702 may activate, at 710, based on the CS-RNTI scrambled DCI1_1 (received at 709), the DL SPS for the reception of DL data at a periodicity. The periodicity may be based on the configuration (received at 706). Referring to FIG. 4, based on the CS-RNTI scrambled DCI1_1 402, the UE may activate the DL SPS for the reception of DL data at a periodicity (e.g., the reception of DL SPS PDSCH at 404, 408, etc.). In some aspects, 904 may be performed by the SPS deactivation component 198.

At 908, the UE may monitor for one or more transmissions associated with the DL SPS based on the periodicity. For example, referring to FIG. 7, UE 702 may, at 712, monitor for one or more transmissions associated with the DL SPS based on the periodicity. In some aspects, 908 may be performed by the SPS deactivation component 198.

At 910, the UE may deactivate the DL SPS based on the one or more transmissions. For example, referring to FIG. 7, UE 702 may deactivate, at 716, the DL SPS based on the one or more transmissions. In some aspects, 910 may be performed by the SPS deactivation component 198.

In some aspects, to obtain the configuration for the DL SPS at 902, the UE may be configured to receive, from a network entity, the configuration for the DL SPS. For example, referring to FIG. 7, UE 702 may, at 706, receive, from a network entity (base station 704), the configuration for the DL SPS.

In some aspects, at 912, the one or more transmissions may include at least one of: one or more PDSCH occasions based on the periodicity, one or more PUCCH occasions based on the periodicity, or one or more PUSCH occasions based on the periodicity. For example, referring to FIG. 7, at 714, the one or more transmissions may include one or more PDSCH occasions, one or more PUCCH occasions, or one or more PUSCH occasions based on the periodicity. Referring to FIG. 4, the one or more transmissions may include one or more PDSCH occasions (e.g., PDSCH 408), one or more PUCCH occasions, or one or more PUSCH occasions (e.g., PUCCH/PUSCH 410) based on the periodicity.

In some aspects, the one or more PUCCH occasions or the one or more PUSCH occasions may carry ACK or NACK feedback for the activation of a DL SPS set. For example, referring to FIG. 4, the one or more PUCCH occasions or the one or more PUSCH occasions (e.g., PUCCH/PUSCH 410) may carry ACK or NACK feedback for the activation of a DL SPS set.

In some aspects, to deactivate the DL SPS at 910, the UE may be configured to, at 914, deactivate, in response to a set of DL SPS misalignment criteria associated with the one or more transmissions being met, the DL SPS. The set of DL SPS misalignment criteria may include: a first number of PDSCH occasions of the one or more PDSCH occasions are identified as failed; no DL SPS retransmissions; and a normal operating condition is met. For example, referring to FIG. 7, at 716, UE 702 may deactivate the DL SPS if a set of DL SPS misalignment criteria associated with the one or more transmissions is met. In one example, the DL SPS misalignment criteria may include X times CS-RNTI PDSCH occasions have CRC failed and no DL SPS retransmission occurs, and a first normal operating condition is met. In another example, the DL SPS misalignment criteria may include all Y times PUSCH occasions have received negative feedback (e.g., NACK) by the network, and a second normal operating condition is met. X and Y are configurable parameters. In some aspects, 914 may be performed by the SPS deactivation component 198.

In some aspects, the first number of PDSCH occasions may include a CS-RNTI. For example, referring to FIG. 4, the first number of PDSCH occasions (e.g., PDSCH 408) may include a CS-RNTI.

In some aspects, the first number of PDSCH occasions may be identified as failed based on CRC associated with the first number of PDSCH occasions. For example, referring to FIG. 5, the first number of PDSCH occasions (e.g., PDSCH at SFN 269, slot 17) may be identified as failed based on CRC associated with the first number of PDSCH occasions (e.g., CRC FAIL 506).

In some aspects, the normal operating condition may include at least one of: the RSRP at the UE is larger than an RSRP threshold, the SSB SNR at the UE is larger than an SNR threshold, or at least one CRC in a PDSCH is passed in a duration of the first number of PDSCH occasions. For example, referring to FIG. 7, when UE 702, at 716, deactivates the DL SPS, the normal operating condition (based on which UE 702 determines whether to deactivate the DL SPS) may include at least one of: the RSRP at UE 702 is larger than an RSRP threshold, the SSB SNR at UE 702 is larger than an SNR threshold, or at least one CRC in a PDSCH is passed in a duration of the first number of PDSCH occasions.

In some aspects, at 906, the UE may configure at least one of the RSRP threshold and the SNR threshold. For example, referring to FIG. 7, UE 702 may configure, at 708, at least one of the RSRP threshold and the SNR threshold. In some aspects, 906 may be performed by the SPS deactivation component 198.

In some aspects, the one or more transmissions may include: feedback for a second number of PUSCH occasions of the one or more PUSCH occasions. The second number of PUSCH occasions may carry the SPS or type 2 A/N feedback for a DL SPS set, and transmissions of the second number of PUSCH occasions may not be interrupted by the UE. The set of DL SPS misalignment criteria may include: the feedback for each of the second number of PUSCH occasions is a NACK, and the normal operating condition is met. For example, referring to FIG. 7, at 714, the one or more transmissions may include feedback for a second number of PUSCH occasions of the one or more PUSCH occasions (at 714), the second number of PUSCH occasions (at 714) may carry the SPS or type 2 A/N feedback for a DL SPS set, and transmissions of the second number of PUSCH occasions (at 714) are not interrupted by UE 702, and the set of DL SPS misalignment criteria may include: the feedback for each of the second number of PUSCH occasions (at 714) is a NACK, and the normal operating condition is met.

In some aspects, the normal operating condition may include at least one of: the RSRP at the UE is larger than an RSRP threshold, the SSB SNR at the UE is larger than an SNR threshold, or at least one PUSCH occasion is acknowledged by a network entity in a duration of the second number of PUSCH occasions. For example, referring to FIG. 7, when UE 702, at 716, deactivates the DL SPS, the normal operating condition (based on which UE 702 determines whether to deactivate the DL SPS) may include at least one of: the RSRP at UE 702 is larger than the RSRP threshold, the SSB SNR at UE 702 is larger than an SNR threshold, or at least one PUSCH occasion is acknowledged by a network entity (base station 704) in a duration of the second number of PUSCH occasions.

In some aspects, to deactivate the DL SPS at 910, the UE may be configured to: at 916, trigger a RACH on the active BWP to deactivate all DL SPS on the UE, or, at 918, deactivate a DL SPS set associated with the one or more transmissions. For example, referring to FIG. 7, UE 702 may, at 718, trigger a RACH on the active BWP to deactivate all DL SPS on UE 702, or, at 720, deactivate a DL SPS set associated with the one or more transmissions. In some aspects, 916 or 918 may be performed by the SPS deactivation component 198.

In some aspects, to deactivate the DL SPS set at 918, the UE may be configured to: deactivate the DL SPS set based on a traffic type associated with the DL SPS set. For example, referring to FIG. 7, UE 702 may deactivate the DL SPS set (at 720) based on a traffic type associated with the DL SPS set.

In some aspects, to monitor for the one or more transmissions associated with the DL SPS based on the periodicity at 908, the UE may be configured to: monitor, in response to an interruption of a PUCCH transmission or a PUSCH transmission from the UE, for the one or more transmissions. For example, referring to FIG. 7, to monitor for the one or more transmissions associated with the DL SPS based on the periodicity (at 712), UE 702 may monitor, in response to an interruption of a PUCCH transmission or a PUSCH transmission from UE 702, for the one or more transmissions. Referring to FIG. 4, the UE may monitor, in response to an interruption of a PUCCH transmission or a PUSCH transmission (e.g., the interruption of PUCCH/PUSCH 406 by the UE), for the one or more transmissions.

In some aspects, the interruption may be caused by a limitation on an MSIM transmission or a suspension or skip on an SSIM transmission. For example, referring to FIG. 4, the interruption (e.g., the interruption of PUCCH/PUSCH 406) may be caused by a limitation on an MSIM transmission or a suspension or skip on an SSIM transmission.

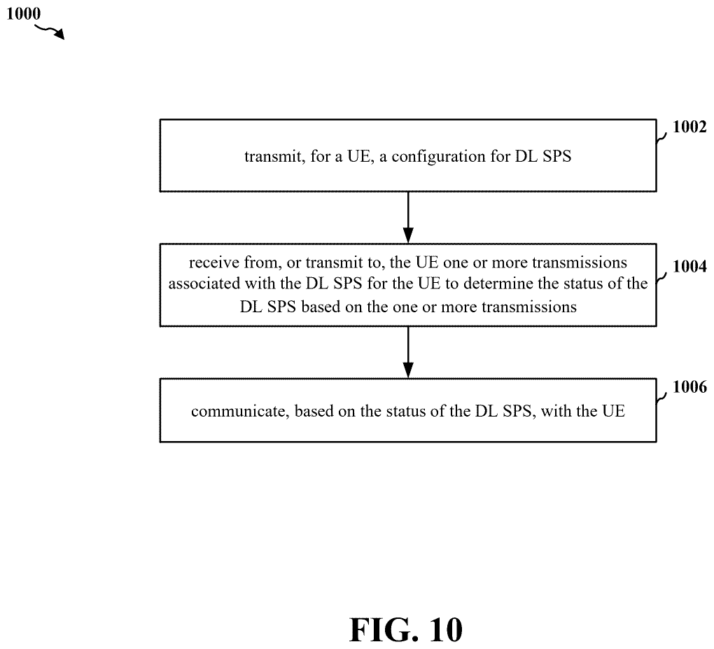

FIG. 10 is a flowchart 1000 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 704; or the network entity 1202 in the hardware implementation of FIG. 12). The methods address the issue of DL SPS status misalignment between the UE and the network in MSIM and SSIM scenarios. The misalignment may lead to significant DL and UL block error rates and increased power consumption. The methods involve deactivating DL SPS on the UE side through triggering RACH or local deactivation, which quickly re-aligns the DL SPS status with the network. The methods improve performance in DL SPS and reduce power consumption by eliminating unnecessary UL transmissions and PDSCH decoding when DL SPS status is misaligned between UE and the network.

As shown in FIG. 10, at 1002, the network entity may transmit, for a UE, a configuration for DL SPS. The UE may be the UE 104, 350, 702, or the apparatus 1204 in the hardware implementation of FIG. 12. FIGS. 4, 5, 6, and 7 illustrate various aspects of the steps in connection with flowchart 1000. For example, referring to FIG. 7, the network entity (base station 704) may transmit, at 706, for UE 702, a configuration for DL SPS. Referring to FIG. 4, the base station may transmit to a UE a configuration for DL SPS. In some aspects, the base station may further send the CS-RNTI scrambled DCI1_1 402 to activate the DL SPS. In some aspects, 1002 may be performed by the SPS deactivation component 199.

At 1004, the network entity may receive from, or transmit to, the UE one or more transmissions associated with the DL SPS for the UE to determine the status of the DL SPS based on the one or more transmissions. For example, referring to FIG. 7, the network entity (base station 704) may, at 714, receive from, or transmit to, UE 702 one or more transmissions associated with the DL SPS. UE 702 may, at 716, determine the status of the DL SPS based on the one or more transmissions (at 714). In some aspects, 1004 may be performed by the SPS deactivation component 199.

At 1006, the network entity may communicate, based on the status of the DL SPS, with the UE. For example, referring to FIG. 7, the network entity (base station 704) may communicate, at 722, based on the status of the DL SPS, with UE 702. In some aspects, 1006 may be performed by the SPS deactivation component 199.

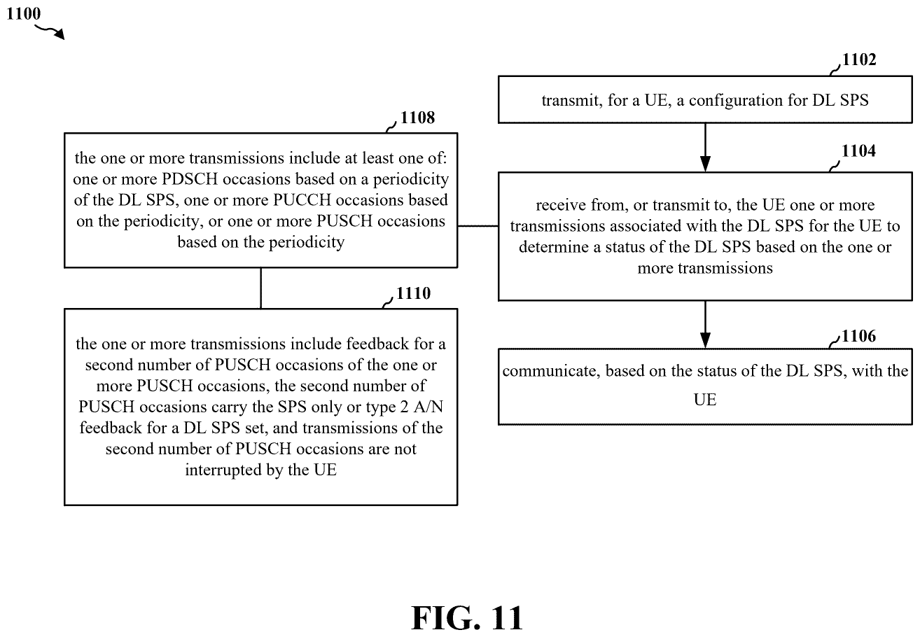

FIG. 11 is a flowchart 1100 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 704; or the network entity 1202 in the hardware implementation of FIG. 12). The methods address the issue of DL SPS status misalignment between the UE and the network in MSIM and SSIM scenarios. The misalignment may lead to significant DL and UL block error rates and increased power consumption. The methods involve deactivating DL SPS on the UE side through triggering RACH or local deactivation, which quickly re-aligns the DL SPS status with the network. The methods improve performance in DL SPS and reduce power consumption by eliminating unnecessary UL transmissions and PDSCH decoding when DL SPS status is misaligned between UE and the network.

As shown in FIG. 11, at 1102, the network entity may transmit, for a UE, a configuration for DL SPS. The UE may be the UE 104, 350, 702, or the apparatus 1204 in the hardware implementation of FIG. 12. FIGS. 4, 5, 6, and 7 illustrate various aspects of the steps in connection with flowchart 1100. For example, referring to FIG. 7, the network entity (base station 704) may transmit, at 706, for UE 702, a configuration for DL SPS. Referring to FIG. 4, the base station may transmit to a UE a configuration for DL SPS. In some aspects, the base station may further send the CS-RNTI scrambled DCI1_1 402 to activate the DL SPS. In some aspects, 1002 may be performed by the SPS deactivation component 199.

At 1104, the network entity may receive from, or transmit to, the UE one or more transmissions associated with the DL SPS for the UE to determine the status of the DL SPS based on the one or more transmissions. For example, referring to FIG. 7, the network entity (base station 704) may, at 714, receive from, or transmit to, UE 702 one or more transmissions associated with the DL SPS. UE 702 may determine, at 716, the status of the DL SPS based on the one or more transmissions (at 714). In some aspects, 1106 may be performed by the SPS deactivation component 199.

At 1106, the network entity may communicate, based on the status of the DL SPS, with the UE. For example, referring to FIG. 7, the network entity (base station 704) may communicate, at 722, based on the status of the DL SPS, with UE 702. In some aspects, 1106 may be performed by the SPS deactivation component 199.

In some aspects, at 1108, the one or more transmissions may include at least one of: one or more PDSCH occasions based on a periodicity of the DL SPS, one or more PUCCH occasions based on the periodicity, or one or more PUSCH occasions based on the periodicity. For example, referring to FIG. 7, the one or more transmissions (at 714) may include one or more PDSCH occasions, one or more PUCCH occasions, or one or more PUSCH occasions based on the periodicity. Referring to FIG. 4, the one or more transmissions may include one or more PDSCH occasions (e.g., PDSCH 408), one or more PUCCH occasions, or one or more PUSCH occasions (e.g., PUCCH/PUSCH 410) based on the periodicity.

In some aspects, the one or more PUCCH occasions or the one or more PUSCH occasions carry ACK or NACK feedback for the activation of a DL SPS set. For example, referring to FIG. 4, the one or more PUCCH occasions or the one or more PUSCH occasions (e.g., PUCCH/PUSCH 410) may carry ACK or NACK feedback for the activation of a DL SPS set.

In some aspects, the status of the DL SPS may include a DL SPS misalignment status. The DL SPS misalignment status may be determined based on a set of DL SPS misalignment criteria. The set of DL SPS misalignment criteria may include: a first number of PDSCH occasions of the one or more PDSCH occasions are identified as failed, no DL SPS retransmissions, and a normal operating condition is met. For example, referring to FIG. 5, the set of DL SPS misalignment criteria may include: a first number of PDSCH occasions of the one or more PDSCH occasions are identified as failed (e.g., CRC FAIL 506 for PDSCH at SFN 269, slot 17), no DL SPS retransmissions, and a normal operating condition is met.

In some aspects, the first number of PDSCH occasions may include a CS-RNTI. For example, referring to FIG. 4, the first number of PDSCH occasions (e.g., PDSCH, 408) may include a CS-RNTI. Referring to FIG. 5, the first number of PDSCH occasions (e.g., PDSCH at SFN 269, slot 17) may include a CS-RNTI.

In some aspects, the first number of PDSCH occasions may be identified as failed based on CRC associated with the first number of PDSCH occasions. For example, referring to FIG. 5, the first number of PDSCH occasions (e.g., PDSCH at SFN 269, slot 17) may be identified as failed based on CRC associated with the first number of PDSCH occasions (e.g., CRC FAIL 506).

In some aspects, the normal operating condition may include at least one of: the RSRP at the UE is larger than an RSRP threshold, the SSB SNR at the UE is larger than an SNR threshold, or at least one CRC in a PDSCH is passed in a duration of the first number of PDSCH occasions. For example, referring to FIG. 7, the normal operating condition may include at least one of: the RSRP at UE 702 is larger than an RSRP threshold, the SSB SNR at UE 702 is larger than an SNR threshold, or at least one CRC in a PDSCH is passed in a duration of the first number of PDSCH occasions.

In some aspects, at 1110, the one or more transmissions may include: feedback for a second number of PUSCH occasions of the one or more PUSCH occasions. The second number of PUSCH occasions may carry the SPS or type 2 A/N feedback for a DL SPS set, and transmissions of the second number of PUSCH occasions are not interrupted by the UE. The status of the DL SPS may include a DL SPS misalignment status. The DL SPS misalignment status may be determined based on a set of DL SPS misalignment criteria, which may include: the feedback for each of the second number of PUSCH occasions is a NACK and a normal operating condition is met. For example, referring to FIG. 7, at 714, the one or more transmissions may include feedback for a second number of PUSCH occasions of the one or more PUSCH occasions (at 714), the second number of PUSCH occasions (at 714) may carry the SPS or type 2 A/N feedback for a DL SPS set, and transmissions of the second number of PUSCH occasions (at 714) are not interrupted by UE 702. The status of the DL SPS may include a DL SPS misalignment status. The DL SPS misalignment status may be determined by UE 702 based on a set of DL SPS misalignment criteria, which may include: the feedback for each of the second number of PUSCH occasions (at 714) is a NACK and a normal operating condition is met.

In some aspects, the normal operating condition may include at least one of: the RSRP at the UE is larger than an RSRP threshold, the SSB SNR at the UE is larger than an SNR threshold, or at least one PUSCH occasion is acknowledged by the network entity in a duration of the second number of PUSCH occasions. For example, referring to FIGS. 4 and 7, the normal operating condition may include at least one of: the RSRP at UE 702 is larger than an RSRP threshold, the SSB SNR at UE 702 is larger than an SNR threshold, or at least one PUSCH occasion is acknowledged by the network entity (base station 704) in a duration of the second number of PUSCH occasions.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see UE 350 of FIG. 3) and include the additional modules of the apparatus 1204.

As discussed supra, the component 198 may be configured to obtain a configuration for DL SPS; activate the DL SPS for the reception of DL data at a periodicity, where the periodicity may be based on the configuration; monitor for one or more transmissions associated with the DL SPS based on the periodicity; and deactivate the DL SPS based on the one or more transmissions. The component 198 may be further configured to perform any of the aspects described in connection with the flowcharts in FIG. 8 and FIG. 9, and/or performed by the UE 702 in FIG. 7. The component 198 may be within the cellular baseband processor 1224, the application processor 1206, or both the cellular baseband processor 1224 and the application processor 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, includes means for obtaining a configuration for DL SPS, means for activating the DL SPS for the reception of DL data at a periodicity, where the periodicity is based on the configuration, means for monitoring for one or more transmissions associated with the DL SPS based on the periodicity, and means for deactivating the DL SPS based on the one or more transmissions. The apparatus 1204 may further include means for performing any of the aspects described in connection with the flowcharts in FIG. 8 and FIG. 9, and/or aspects performed by the UE 702 in FIG. 7. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

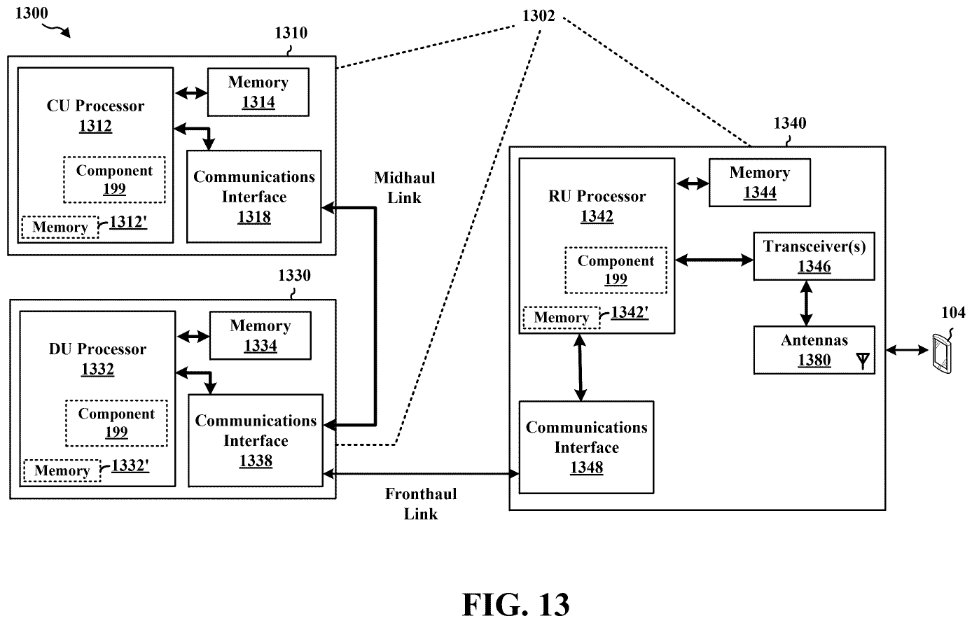

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit, for a UE, a configuration for DL SPS; receive from, or transmit to, the UE one or more transmissions associated with the DL SPS for the UE to determine the status of the DL SPS based on the one or more transmissions; and communicate, based on the status of the DL SPS, with the UE. The component 199 may be further configured to perform any of the aspects described in connection with the flowcharts in FIG. 10 and FIG. 11, and/or performed by the base station 704 in FIG. 7. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions. In one configuration, the network entity 1302 includes means for transmitting, for a UE, a configuration for DL SPS, means for receiving from, or transmitting to, the UE one or more transmissions associated with the DL SPS for the UE to determine the status of the DL SPS based on the one or more transmissions, and means for communicating, based on the status of the DL SPS, with the UE. The network entity 1302 may further include means for performing any of the aspects described in connection with the flowcharts in FIG. 10 and FIG. 11, and/or aspects performed by the base station 704 in FIG. 7. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include obtaining a configuration for DL SPS; activating the DL SPS for the reception of DL data at a periodicity, where the periodicity is based on the configuration; monitoring for one or more transmissions associated with the DL SPS based on the periodicity; and deactivating the DL SPS based on the one or more transmissions. The methods address the issue of DL SPS status misalignment between the UE and the network in MSIM and SSIM scenarios. The misalignment may lead to significant DL and UL block error rates and increased power consumption. The methods involve deactivating DL SPS on the UE side through triggering RACH or local deactivation, which quickly re-aligns the DL SPS status with the network. The methods improve performance in DL SPS and reduce power consumption by eliminating unnecessary UL transmissions and PDSCH decoding when DL SPS status is misaligned between UE and the network.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE). The method may comprise obtaining a configuration for downlink (DL) semi-persistent scheduling (SPS); activating the DL SPS for the reception of DL data at a periodicity, wherein the periodicity is based on the configuration; monitoring for one or more transmissions associated with the DL SPS based on the periodicity; and deactivating the DL SPS based on the one or more transmissions.

Aspect 2 is the method of aspect 1, wherein obtaining the configuration for the DL SPS may include receiving, from a network entity, the configuration for the DL SPS.

Aspect 3 is the method of any of aspects 1 to 2, wherein the one or more transmissions may comprise at least one of: one or more physical downlink shared channel (PDSCH) occasions based on the periodicity, one or more physical uplink control channel (PUCCH) occasions based on the periodicity, or one or more PUSCH occasions based on the periodicity.

Aspect 4 is the method of aspect 3, wherein the one or more PUCCH occasions or the one or more PUSCH occasions may carry acknowledgement (ACK) or negative-ACK (NACK) feedback for the activation of a DL SPS set.

Aspect 5 is the method of any of aspects 3 to 4, wherein deactivating the DL SPS may include: deactivating, in response to a set of DL SPS misalignment criteria associated with the one or more transmissions being met, the DL SPS, and the set of DL SPS misalignment criteria may include: a first number of PDSCH occasions of the one or more PDSCH occasions are identified as failed; no DL SPS retransmissions; and a normal operating condition is met.

Aspect 6 is the method of aspect 5, wherein the first number of PDSCH occasions may include a configured scheduling radio network temporary identifier (CS-RNTI).

Aspect 7 is the method of aspect 5, wherein the first number of PDSCH occasions may be identified as failed based on a cyclic redundancy check (CRC) associated with the first number of PDSCH occasions.

Aspect 8 is the method of any of aspects 5 to 7, wherein the normal operating condition may include at least one of: a reference signal received power (RSRP) at the UE is larger than an RSRP threshold, a synchronization signal block (SSB) signal-to-noise ratio (SNR) at the UE is larger than an SNR threshold, or at least one CRC in a PDSCH is passed in a duration of the first number of PDSCH occasions.

Aspect 9 is the method of any of aspects 1 to 8, wherein the method may further include configuring at least one of the RSRP threshold and the SNR threshold.

Aspect 10 is the method of aspect 5, wherein the one or more transmissions may include feedback for a second number of PUSCH occasions of the one or more PUSCH occasions, wherein the second number of PUSCH occasions may carry an SPS or type 2 A/N feedback for a DL SPS set, and transmissions of the second number of PUSCH occasions may not be interrupted by the UE, and wherein the set of DL SPS misalignment criteria may include: the feedback for each of the second number of PUSCH occasions is a negative-acknowledgement (NACK), and the normal operating condition is met.

Aspect 11 is the method of aspect 10, wherein the normal operating condition may include at least one of: a reference signal received power (RSRP) at the UE is larger than an RSRP threshold, a synchronization signal block (SSB) signal-to-noise ratio (SNR) at the UE is larger than an SNR threshold, or at least one PUSCH occasion is acknowledged by a network entity in a duration of the second number of PUSCH occasions.

Aspect 12 is the method of any of aspects 1 to 11, wherein deactivating the DL SPS may include at least one of: triggering a random-access channel (RACH) on the active bandwidth part (BWP) to deactivate all DL SPS on the UE, or deactivating a DL SPS set associated with the one or more transmissions.

Aspect 13 is the method of aspect 12, wherein deactivating the DL SPS set may include: deactivating the DL SPS set based on a traffic type associated with the DL SPS set.

Aspect 14 is the method of any of aspects 1 to 13, wherein monitoring for the one or more transmissions associated with the DL SPS based on the periodicity may include: monitoring, in response to an interruption of a physical uplink control channel (PUCCH) transmission or a PUSCH transmission from the UE, for the one or more transmissions.

Aspect 15 is the method of aspect 14, wherein the interruption may be caused by a limitation on a multiple subscriber identity module (MSIM) transmission or a suspension or skip on a single subscriber identity module (SSIM) transmission.

Aspect 16 is an apparatus for wireless communication at a UE, including: a memory; and at least one processor coupled to the memory and, based at least in part on information stored in the memory, the at least one processor is configured to perform the method of any of aspects 1-15.

Aspect 17 is the apparatus of aspect 16, further including at least one of a transceiver or an antenna coupled to the at least one processor and configured to obtain the configuration for DL SPS.

Aspect 18 is an apparatus for wireless communication including means for implementing the method of any of aspects 1-15.

Aspect 19 is a computer-readable medium (e.g., a non-transitory computer-readable medium) storing computer executable code, where the code when executed by a processor causes the processor to implement the method of any of aspects 1-15.

Aspect 20 is a method of wireless communication at a network entity. The method may comprise transmitting, for a user equipment (UE), a configuration for downlink (DL) semi-persistent scheduling (SPS); receiving from, or transmitting to, the UE one or more transmissions associated with the DL SPS for the UE to determine a status of the DL SPS based on the one or more transmissions; and communicating, based on the status of the DL SPS, with the UE.

Aspect 21 is the method of aspect 20, wherein the one or more transmissions may comprise at least one of: one or more physical downlink shared channel (PDSCH) occasions based on a periodicity of the DL SPS, one or more physical uplink control channel (PUCCH) occasions based on the periodicity, or one or more physical uplink shared channel (PUSCH) occasions based on the periodicity.

Aspect 22 is the method of aspect 21, wherein the one or more PUCCH occasions or the one or more PUSCH occasions may carry acknowledgement (ACK) or negative-ACK (NACK) feedback for the activation of a DL SPS set.

Aspect 23 is the method of any of aspects 21 to 22, wherein the status of the DL SPS may include a DL SPS misalignment status, and the DL SPS misalignment status may be based on a set of DL SPS misalignment criteria, comprising: a first number of PDSCH occasions of the one or more PDSCH occasions are identified as failed, no DL SPS retransmissions, and a normal operating condition is met.

Aspect 24 is the method of aspect 23, wherein the first number of PDSCH occasions may include a configured scheduling radio network temporary identifier (CS-RNTI).

Aspect 25 is the method of aspect 23, wherein the first number of PDSCH occasions may be identified as failed based on cyclic redundancy check (CRC) associated with the first number of PDSCH occasions.

Aspect 26 is the method of any of aspects 23 to 25, wherein the normal operating condition may include at least one of: a reference signal received power (RSRP) at the UE is larger than an RSRP threshold, a synchronization signal block (SSB) signal-to-noise ratio (SNR) at the UE is larger than an SNR threshold, or at least one CRC in a PDSCH is passed in a duration of the first number of PDSCH occasions.

Aspect 27 is the method of aspect 21, wherein the one or more transmissions may comprise feedback for a second number of PUSCH occasions of the one or more PUSCH occasions, wherein the second number of PUSCH occasions may carry an SPS or type 2 A/N feedback for a DL SPS set, and transmissions of the second number of PUSCH occasions are not interrupted by the UE, and wherein the status of the DL SPS includes a DL SPS misalignment status, and the DL SPS misalignment status is based on a set of DL SPS misalignment criteria, comprising: the feedback for each of the second number of PUSCH occasions is a negative-acknowledgement (NACK), and a normal operating condition is met.

Aspect 28 is the method of aspect 27, wherein the normal operating condition includes at least one of: a reference signal received power (RSRP) at the UE is larger than an RSRP threshold, a synchronization signal block (SSB) signal-to-noise ratio (SNR) at the UE is larger than an SNR threshold, or at least one PUSCH occasion is acknowledged by the network entity in a duration of the second number of PUSCH occasions.

Aspect 29 is an apparatus for wireless communication at a network entity, including: a memory; and at least one processor coupled to the memory and, based at least in part on information stored in the memory, the at least one processor is configured to perform the method of any of aspects 20-28.

Aspect 30 is the apparatus of aspect 29, further including at least one of a transceiver or an antenna coupled to the at least one processor and configured to transmit the configuration for DL SPS.

Aspect 31 is an apparatus for wireless communication including means for implementing the method of any of aspects 20-28.

Aspect 32 is a computer-readable medium (e.g., a non-transitory computer-readable medium) storing computer executable code, where the code when executed by a processor causes the processor to implement the method of any of aspects 20-28.

1. An apparatus of wireless communication at a user equipment (UE), comprising:
memory; and
at least one processor coupled to the memory and, based at least in part on information stored in the memory, the at least one processor is configured to:
obtain a configuration for downlink (DL) semi-persistent scheduling (SPS);
activate the DL SPS for a reception of DL data at a periodicity, wherein the periodicity is based on the configuration;
monitor for one or more transmissions associated with the DL SPS based on the periodicity; and
deactivate the DL SPS based on the one or more transmissions.

2. The apparatus of claim 1, further comprising a transceiver coupled to the at least one processor, wherein, to obtain the configuration for the DL SPS, the at least one processor is configured to obtain, via the transceiver, the configuration for the DL SPS, and wherein, to obtain the configuration for the DL SPS, the at least one processor is configured to:
receive, from a network entity, the configuration for the DL SPS.

3. The apparatus of claim 1, wherein the one or more transmissions comprise at least one of:
one or more physical downlink shared channel (PDSCH) occasions based on the periodicity,
one or more physical uplink control channel (PUCCH) occasions based on the periodicity, or
one or more physical uplink shared channel (PUSCH) occasions based on the periodicity.

4. The apparatus of claim 3, wherein the one or more PUCCH occasions or the one or more PUSCH occasions carry acknowledgement (ACK) or negative-ACK (NACK) feedback for an activation of a DL SPS set.

5. The apparatus of claim 3, wherein, to deactivate the DL SPS, the at least one processor is configured to:
deactivate, in response to a set of DL SPS misalignment criteria associated with the one or more transmissions being met, the DL SPS, and wherein the set of DL SPS misalignment criteria comprises:
a first number of PDSCH occasions of the one or more PDSCH occasions are identified as failed;
no DL SPS retransmissions; and
a normal operating condition is met.

6. The apparatus of claim 5, wherein the first number of PDSCH occasions include a configured scheduling radio network temporary identifier (CS-RNTI).

7. The apparatus of claim 5, wherein the first number of PDSCH occasions are identified as failed based on a cyclic redundancy check (CRC) associated with the first number of PDSCH occasions.

8. The apparatus of claim 5, wherein the normal operating condition includes at least one of:
a reference signal received power (RSRP) at the UE is larger than an RSRP threshold,
a synchronization signal block (SSB) signal-to-noise ratio (SNR) at the UE is larger than an SNR threshold, or
at least one CRC in a PDSCH is passed in a duration of the first number of PDSCH occasions.

9. (canceled)

10. The apparatus of claim 5, wherein the one or more transmissions comprise:
feedback for a second number of PUSCH occasions of the one or more PUSCH occasions, wherein the second number of PUSCH occasions carry an SPS or type 2 A/N feedback for a DL SPS set, and transmissions of the second number of PUSCH occasions are not interrupted by the UE, and wherein the set of DL SPS misalignment criteria comprise:
the feedback for each of the second number of PUSCH occasions is a negative-acknowledgement (NACK), and
the normal operating condition is met.

11. (canceled)

12. The apparatus of claim 1, wherein, to deactivate the DL SPS, the at least one processor is configured to:
trigger a random-access channel (RACH) on an active bandwidth part (BWP) to deactivate all DL SPS on the UE, or
deactivate a DL SPS set associated with the one or more transmissions.

13. (canceled)

14. The apparatus of claim 1, wherein, to monitor for the one or more transmissions associated with the DL SPS based on the periodicity, the at least one processor is configured to:
monitor, in response to an interruption of a physical uplink control channel (PUCCH) transmission or a PUSCH transmission from the UE, for the one or more transmissions.

15. (canceled)

16. An apparatus of wireless communication at a network entity, comprising:
memory; and
at least one processor coupled to the memory and, based at least in part on information stored in the memory, the at least one processor is configured to:
transmit, for a user equipment (UE), a configuration for downlink (DL) semi-persistent scheduling (SPS);
receive from, or transmit to, the UE one or more transmissions associated with the DL SPS for the UE to determine a status of the DL SPS based on the one or more transmissions; and
communicate, based on the status of the DL SPS, with the UE.

17. The apparatus of claim 16, further comprising a transceiver coupled to the at least one processor, wherein, to transmit the configuration for the DL SPS, the at least one processor is configured to transmit, via the transceiver, the configuration for the DL SPS, and wherein the one or more transmissions comprise at least one of:
one or more physical downlink shared channel (PDSCH) occasions based on a periodicity of the DL SPS,
one or more physical uplink control channel (PUCCH) occasions based on the periodicity, or
one or more physical uplink shared channel (PUSCH) occasions based on the periodicity.

18. The apparatus of claim 17, wherein the one or more PUCCH occasions or the one or more PUSCH occasions carry acknowledgement (ACK) or negative-ACK (NACK) feedback for an activation of a DL SPS set.

19. The apparatus of claim 17, wherein the status of the DL SPS includes a DL SPS misalignment status, wherein the DL SPS misalignment status is based on a set of DL SPS misalignment criteria, comprising:
a first number of PDSCH occasions of the one or more PDSCH occasions are identified as failed,
no DL SPS retransmissions, and
a normal operating condition is met.

20. (canceled)

21. (canceled)

22. (canceled)

23. The apparatus of claim 17, wherein the one or more transmissions comprise:
feedback for a second number of PUSCH occasions of the one or more PUSCH occasions, wherein the second number of PUSCH occasions carry an SPS or type 2 A/N feedback for a DL SPS set, and transmissions of the second number of PUSCH occasions are not interrupted by the UE, and wherein the status of the DL SPS includes a DL SPS misalignment status, and the DL SPS misalignment status is based on a set of DL SPS misalignment criteria, comprising:
the feedback for each of the second number of PUSCH occasions is a negative-acknowledgement (NACK), and
a normal operating condition is met.

24. The apparatus of claim 23, wherein the normal operating condition includes at least one of:
a reference signal received power (RSRP) at the UE is larger than an RSRP threshold,
a synchronization signal block (SSB) signal-to-noise ratio (SNR) at the UE is larger than an SNR threshold, or
at least one PUSCH occasion is acknowledged by the network entity in a duration of the second number of PUSCH occasions.

25. A method of wireless communication at a user equipment (UE), comprising:
obtaining a configuration for downlink (DL) semi-persistent scheduling (SPS);
activating the DL SPS for a reception of DL data at a periodicity, wherein the periodicity is based on the configuration;
monitoring for one or more transmissions associated with the DL SPS based on the periodicity; and
deactivating the DL SPS based on the one or more transmissions.

26. The method of claim 25, wherein obtaining the configuration for the DL SPS comprises receiving, from a network entity, the configuration for the DL SPS.

27. The method of claim 25, wherein the one or more transmissions comprise at least one of:
one or more physical downlink shared channel (PDSCH) occasions based on the periodicity,
one or more physical uplink control channel (PUCCH) occasions based on the periodicity, or
one or more physical uplink shared channel (PUSCH) occasions based on the periodicity.

28. (canceled)

29. (canceled)

30. (canceled)
